(19) United States
(12) Patent Application Publication
(10) Pub. No.: US 2009/0161621 A1
(43) Pub. Date: Jun. 25, 2009

(54) COMMUNICATION METHOD AND RADIO COMMUNICATION APPARATUS

(75) Inventor: Junichi SUGA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/340,720

(22) Filed: Dec. 21, 2008

(30) Foreign Application Priority Data
Dec. 21, 2007 (JP) 2007-329655

(51) Int. Cl. H04W 28/16

(52) U.S. Cl. 370/329

(57) ABSTRACT

A communication method for a radio communication system in which a second radio communication apparatus transmits a radio signal with a transmission radio resource designated by a first radio communication apparatus, the communication method includes designating, by the first radio communication apparatus, a transmission radio resource for data and a control signal to the second radio communication apparatus; transmitting, by the second communication apparatus, transmission data and a control signal with the designated transmission radio resource; and determining, by the first radio communication apparatus, whether a further allocation of a transmission radio resource for data to the second radio communication apparatus in response to a reception result of the transmission data is performed or not based on the control signal.

### CROSS-REFERENCE TO RELATED APPLICATIONS

This application is based upon and claims the benefit of priority of the prior Japanese Patent Application No. 2007-329655, filed on Dec. 21, 2007, the entire contents of which are incorporated herein by reference.

### FIELD

Certain aspects of the present invention discussed herein are related to a communication method and radio communication apparatus which use radio communication technique as communication means.

### BACKGROUND

Various communication methods using radio communication as a communication means are known.

FIG. 1 is an example of a known radio communication system. In FIG. 1, a plurality of MSs 21 to 23 (Mobile stations) communicate with a BS 1 (Base station) by radio communication. In the radio communication system, the base station serving as a radio communication apparatus may designate transmission regions (transmission radio resources) to a plurality of mobile stations serving as radio communication apparatuses.

For example, the base station notifies the mobile station of transmission region (radio resource) designation information which designates a transmission region (radio resource), or reception region (radio resource) designation information which designates a reception region (radio resource) for each radio frame. According to this, the base station can control a transmission operation and a reception operation of the mobile station for each radio frame. For this reason, precise management of radio resources can be realized.

Also in a radio communication system studied by IEEE802.16 Working Group, a base station designates a transmission region (radio resource) to a mobile station for each of radio frames. By using FIG. 2, transmission region (radio resource) designation information and reception region (radio resource) designation information used in the radio communication system will be described below (see Non-patent Documents 1 and 2).

FIG. 2 is a structure of a radio frame transmitted from a base station.

The ordinate axis indicates a frequency and shows that a radio frame is transmitted by using a plurality of different frequencies. The abscissa axis indicates time and shows that a radio frame is transmitted over a predetermined period. As the radio frame, one radio frame is illustrated. When transmission of one radio frame is completed, the next radio frame is transmitted. The next radio frame can store different data, and the division of transmission regions (radio resources) of each burst can also be changed. Preferably, each radio frame is transmitted such that a preamble is transmitted in a certain cycle.

In FIG. 2, DL Sub-frame denotes a downlink sub-frame included in one radio frame, wherein a direction from the base station to the mobile station is called a downlink direction. Therefore, the base station performs transmission by using the downlink sub-frame. On the other hand, UL Sub-frame denotes an uplink sub-frame included in one radio frame, wherein a direction from the mobile station to the base station is called an uplink direction. Therefore, each mobile station performs transmission by using the uplink sub-frame.

The downlink sub-frame includes a preamble, a DL-MAP, a UL-MAP, and a plurality of downlink bursts (in FIG. 2, DL Bursts No. 1 to No. 4).

The preamble is a signal having a known certain pattern transmitted by a head of a frame, and each mobile station can detect the head of the frame by detecting the preamble. Preambles having different patterns can be transmitted from base stations, respectively.

DL-MAP denotes information which defines a transmission frequency, a transmission time period, or the like, of data included in the downlink sub-frame. Each mobile station receives the DL-MAP to make it possible to recognize reception region (radio resource) information representing a specific frequency by which reception should be performed and a specific time period in which the reception should be performed. Therefore, it can be said that the DL-MAP is reception region (radio resource) designation information to the mobile station. In the DL-MAP, since a CID (Connection Identifier) is associated with a reception region (radio resource), the mobile station may perform reception of a reception region (radio resource) specified by an information part of the DL-MAP matched with a CID to be received by the mobile station itself. For example, a mobile station which desires to receive a DL Burst associated with CID=1 searches the DL-MAP for a transmission frequency and a transmission time period associated with CID=1. When reception is performed conforming to the transmission frequency and the transmission time period, for example, the mobile station can receive data transmitted by the DL Burst No. 1 associated with CID=1.

The UL-MAP is information which defines a reception frequency, a reception time period, or the like, of data included in the uplink sub-frame. The mobile station receives the UL-MAP to make it possible to recognize transmission region (radio resource) information representing a specific frequency by which transmission is performed and a specific time period in which the transmission is performed. Therefore, it can be said that the UL-MAP is transmission region (radio resource) designation information to the mobile station.

For example, in the UL-MAP, the base station notifies the mobile station of a specific frequency and a specific time period of a transmission region (radio resource) (CDMA Region (transmission radio resource for CDMA code) in which a ranging code is transmitted when the mobile station performs network entry or the like). For example, when the base station causes a mobile station which performs communication CID=2 to execute transmission in the UL Burst No. 2, the base station transmits a UL-MAP including a frequency and time period information corresponding to the UL Burst No. 2 in association with CID=2.

As described above, the base station transmits transmission region (radio resource) designation information and reception region (radio resource) designation information for each radio frame to make it possible to sensitively control transmission and reception operations of the mobile station.

As described above, in the radio communication system, one radio communication apparatus may designate a transmission region (radio resource) of data to another radio communication apparatus.

A transmission region (radio resource) of further data may be allocated depending on a reception result of the data transmitted with the designated transmission region (radio resource).

However, a reception result of data in one radio communication apparatus cannot be easily completely predicted in another radio communication apparatus. An unintended transmission region (radio resource) may be allocated. In contrast to this, an intended transmission region (radio resource) may not be allocated.

### SUMMARY

Accordingly, it is an object in an aspect of the invention to enable to cause a radio communication apparatus to which a transmission radio resource, namely a radio resource used for transmission, is designated to give a chance to be concerned about an allocation determination of a further transmission radio resource in a radio communication apparatus which designates a transmission radio resource.

According to one aspect of the invention, a communication method for a radio communication system in which a second radio communication apparatus transmits a radio signal with a transmission radio resource designated by a first radio communication apparatus includes designating, by the first radio communication apparatus, a transmission radio resource for data and a control signal to the second radio communication apparatus; transmitting, by the second communication apparatus, transmission data and a control signal with the designated transmission radio resource; and determining, by the first radio communication apparatus, whether a further allocation of a transmission radio resource for data to the second radio communication apparatus in response to a reception result of the transmission data is performed or not based on the control signal.

Preferably, the further allocation of the transmission radio resource for the data corresponds to an allocation of a transmission radio resource for retransmission data of the transmission data or a transmission radio resource for another transmission data different from the transmission data.

Preferably, the control signal, when the reception result indicates that reception is not normally performed, indicates that allocation of a transmission radio resource for retransmission data to the second radio communication apparatus is unnecessary or that allocation of a transmission radio resource of retransmission data to the second radio communication apparatus is necessary.

Preferably, the transmission data and the control data are transmitted in a same radio frame.

Preferably, designation of the transmission radio resource for the data or the control signal by the first radio communication apparatus is performed frame by frame.

Preferably designation of the transmission radio resource by the first radio communication apparatus is performed by separately designating the transmission radio resource for the data and the transmission radio resource for the control signal.

According to one aspect of the invention, a radio communication apparatus corresponding to a first radio communication apparatus in a radio communication system in which a second radio communication apparatus transmits a radio signal with a transmission radio resource designated by the first radio communication apparatus includes a controller configured to generate designation information including designation of transmission radio resource for data and a control signal to the second radio communication apparatus; a transmitter configured to transmit the designation information generated by the controller; and a receiver configured to receive a transmission data and a control signal from the second radio communication apparatus with the designated transmission radio resource, wherein the controller determines whether a further allocation of transmission radio resource for data to the second radio communication apparatus in response to a reception result of the transmission data received is performed based on the control signal received.

According to one aspect of the invention, a radio communication apparatus corresponding to a second radio communication apparatus in a radio communication system in which the second radio communication apparatus transmits a radio signal with a transmission radio resource designated by a first radio communication apparatus includes a receiver configured to receive designation information including designation of transmission radio resource for data and a control signal from the first radio communication apparatus;

a transmitter configured to transmit a radio signal to the first radio communication apparatus; and a controller configured to control the transmitter to transmit a transmission data and a control signal with the transmission radio resource designated by the designation information, wherein the control signal is used, by the first radio communication apparatus, in a determination whether a further allocation of a transmission radio resource of data in response to a reception result of the transmission data is performed or not.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a radio communication system;

FIG. 2 is an example of a radio frame;

FIG. 3 is a configuration example (part 1) of a radio communication system;

FIG. 4 is a diagram of a transmission region (radio resource) allocating process of further data;

FIG. 5 is an example of a configuration (part 2) of a radio communication apparatus (base station);

FIG. 6 is an example of a configuration of a UL-MAP;

FIG. 7 is an example of a configuration of a UL HARQ Chase Sub-Burst IE;

FIG. 8 is an example of a configuration of a UL HARQ Flag Region (radio resource) Allocation IE;

FIG. 9 is an example of a configuration (part 2) of a radio communication apparatus (terminal);

FIG. 10 is an example of a procedure of a re-transmission control;

FIG. 11 is an example of an operation flow of a terminal;

FIG. 12 is an example of an operation flow of a base station;

FIG. 13 is a configuration example of a UL HARQ Flag Allocation Region (radio resource);

FIG. 14 is a diagram showing a relationship between the UL HARQ Chase Sub-Burst IE and the UL HARQ Flag Allocation region (radio resource);

FIG. 15 is a configuration example of the UL HARQ Chase Sub-Burst IE; and

FIG. 16 is a diagram showing a relationship between the UL HARQ Chase Sub-Burst IE and the UL HARQ Flag Allocation Region (radio resource).

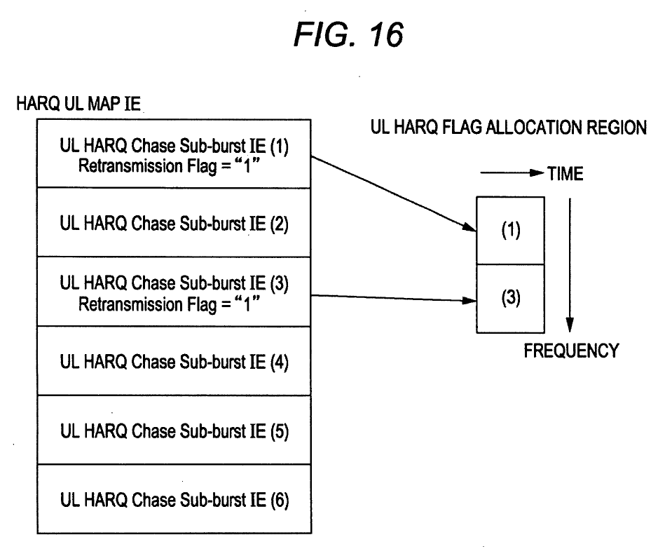

### DESCRIPTION OF EMBODIMENTS

Embodiments for carrying out the present invention are described with reference to the figures.

In the embodiments, in a communication method for a radio communication system in which a radio communication apparatus (20) transmits a radio signal with a transmission radio resource designated by a radio communication apparatus (10), the radio communication apparatus (10) designates a transmission radio resource of data and a control signal to the radio communication apparatus (20), the radio communication apparatus (20) transmits transmission data and a control signal with the designated transmission radio resource, and the radio communication apparatus (10) determines whether a further allocation of a transmission radio resource for data to the radio communication apparatus (20) in response to a reception result of the transmission data is performed based on the control signal.

Therefore, since the radio communication apparatus (20) can transmit data with a designated transmission region (radio resource) and can transmit a control signal, the radio communication apparatus (20) may be involved in an operation to determine whether a further allocation of a transmission region (radio resource) for data to the radio communication apparatus (20) by the radio communication apparatus (10) in response to a reception result of the transmission data is performed or not based on the control signal.

For example, when the transmission data is data which is not required to be re-transmitted, since the radio communication apparatus (10) is notified by a control signal indicating that the data is not required to be re-transmitted, unnecessary allocation of a transmission region (radio resource) of re-transmission data is suppressed from being executed.

The embodiments of the present invention will be described below with reference to the accompanying drawings.

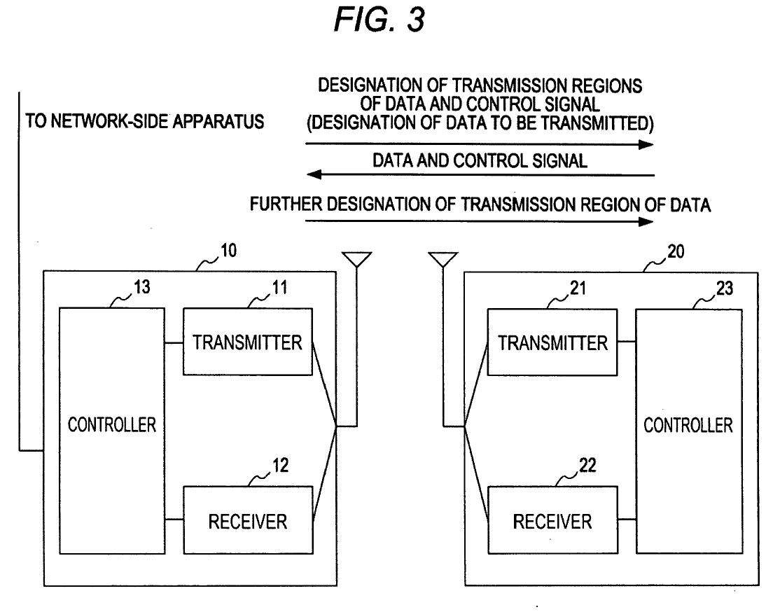

FIG. 3 is an example of a radio communication system.

In FIG. 3, reference numeral 10 denotes a radio communication apparatus that designates a transmission region (radio resource), and 20 denotes a radio communication apparatus that transmits a radio signal with the designated transmission region (radio resource).

The radio communication apparatus 10 includes a transmitter 11 connected to an antenna, a receiver 12, and a controller 13. The antenna, the transmitter 11, and the receiver 12 are connected to each other through an antenna sharing unit (not shown).

The transmitter 11 transmits a signal given by the controller 13 from the antenna as a radio signal. As a modulation method, for example, QAM, QPSK, or the like may also be used. When a plurality of radio communication apparatuses 20 are present, as a multiplexing method, CDMA, OFDM (OFDMA), TDMA, FDMA, or the like may also be used.

The controller 13 controls various units such as the transmitter 11 and the receiver 12 and generates a signal to be transmitted to the radio communication apparatus 20.

More specifically, the controller 13 generates designation information, which designates transmission region (radio resource) for data, and a control signal to give the designation information to the transmitter 11. At this time, designation related to data to be transmitted with the transmission region (radio resource) may be included in the designation information.

The receiver 12 performs a receiving process on the radio signal received by the antenna and gives a reception result to the controller 13.

The radio communication apparatus 20 includes a transmitter 21 connected to an antenna, a receiver 22, and a controller 23. The antenna, the transmitter 21, and the receiver 22 are connected to each other through an antenna sharing unit (not shown).

The transmitter 21 transmits a signal given by the controller 23 from the antenna as a radio signal. As a modulation method, for example, QAM, QPSK, or the like may also be used. When a plurality of radio communication apparatuses 20 are present, as a multiplexing method, CDMA, OFDM (OFDMA), TDMA, FDMA, or the like may also be used.

The controller 23 controls various units such as the transmitter 21 and the receiver 22 and generates a signal to be transmitted to the radio communication apparatus 10.

The receiver 22 performs a receiving process on a radio signal received by the antenna to give a reception result to the controller 23.

As described above, since the radio communication apparatus 10 transmits designation information generated by the controller 13, the receiver 22 receives the designation information and gives a reception result to the controller 23. The controller 23 analyzes the designation information included in the reception signal to determine a way of controlling the transmitter 21. More specifically, the transmitter 21 is controlled to execute transmission with a transmission region (radio resource) designated by the designation information. When the designation information includes a transmission frequency (or a plurality of frequencies as in OFDMA) and a time period, the transmitter 21 is instructed to perform transmission at the designated frequency in the designated time period.

When the controller 23 receives not only designation of a transmission region (radio resource) but also designation related to data to be transmitted with the transmission region (radio resource), data is transmitted from the transmitter 21 as instructed by the controller 23 conforming to the designation related to the data. As the designation, for example, a type of data may be designated. Control data, user data, audio data, image data, high-priority data, new data, retransmission data, or the like may be designated. A transmission format (modulation method and encoding rate) or the like may be used for the designation.

The controller 23 gives, to the transmitter 21, a signal (control signal P) which can be used to determine whether or not further allocation of a transmission region (radio resource) for further data to the radio communication apparatus 20 is performed by the radio communication apparatus 10 in response to the reception result of the transmission data.

The data and the control signal P are transmitted from the transmitter 21 with the designated transmission region (radio resource). The data and the control signal P may be given to the transmitter 21 as a set.

As the control signal P, a signal (P1) indicating that a transmission region (radio resource) of further data is required to be allocated (required allocation) or, in contrast to this, a signal (P2) indicating that the transmission region (radio resource) of the further data is not required to be allocated (unrequired allocation) may also be used. At this time, as the transmission region (radio resource) of the further data, a transmission region (radio resource) of retransmission data obtained when the radio communication apparatus 10 fails in reception of the transmission data transmitted from the radio communication apparatus 20 may be used.

For example, when the radio communication apparatus 20 requires allocation of a transmission region (radio resource) of further data, the radio communication apparatus 20 transmits the signal P1 (does not transmit P2). When the radio communication apparatus 20 does not require the transmission region (radio resource) of the further data, the radio communication apparatus 20 may also transmit the signal P2 (does not transmit P1).

Even though any one of the signals P1 and P2 may be used, in the radio communication apparatus 10, either of the signals P1 or P2 may be used to determine whether allocation of the transmission region (radio resource) of the further data to the radio communication apparatus 20 is performed or not.

The signals P1 and P2 are preferably transmitted in a certain transmission format or conforming to a designated transmission format.

The controller 23 generally gives data of a designated type and information of a designated transmission format to the transmitter 21. At this time, the controller 23 may give a control signal (C1) indicating that the data is transmitted conforming to a designation to the transmitter 21. In this case, a designated transmission region (radio resource), the data and the control signal (C1) are transmitted from the transmitter 21. The data and the control signal (C1) may be given to the transmitter 21 as a set. When a control signal (C2), indicating that the data is not data which does not conform to the designated type of the data, is not transmitted, the controller 23 can also report that the data conforms to the designated type of the data. The data may also be transmitted conforming to the designated transmission type.

When the transmission format is designated, the controller 23 instructs the transmitter 21 to transmit data in the designated transmission format, and the transmitter 21 transmits the data in the format. At this time, as a control signal, the signal C1 is transmitted. As the signal C1, information indicating a transmission format of data to be actually transmitted may also be used.

Depending on the situation, data of a type different from that of the designated data may be given to the transmitter 21. At this time, the controller 23 gives, to the transmitter 21, the control signal (C2) indicating that the data does not conform to the type of the data designated by the designation information and gives the data of the different type, to cause the transmitter 21 to transmit the control signal (C2) and the data of the different type. Although the signal C2 is transmitted with the designated transmission region (radio resource), it may be information indicating the type of the data which does not conform to the designation.

When the data of the designated type is transmitted, if the signal C1 is transmitted, the signal C1 may not transmitted to notify the radio communication apparatus 10 that the data is not the data of the designated type. When the data of the designated type is transmitted, regardless of transmission of the signal C1, the signal C2 may also be transmitted to report that the data is not the data of the designated type. In any case, the radio communication apparatus 10 may be notified that the data is not the data of the designated type.

When the transmission format is designated, the controller 23 instructs the transmitter 21 to perform transmission in a transmission format different from the designated transmission format, and the transmitter 21 transmits in the different transmission format. At this time, as a control signal, the signal C2 is transmitted. The signal C2 can also be used as information that does not conform to the designated transmission format and indicates an actual transmission format. When the transmission format is to be changed, a transmission format in which a region (radio resource) of a radio resource required for transmission becomes narrow is desirably selected. For example, for designation of QPSK, a change into 16 QAM is performed. In this manner, a larger amount of information can also be transmitted with the designated region (radio resource). This operation can also be reversed. When the radio communication apparatus 20 has a measurement unit (CINR measurement unit, SIR measurement unit, level measurement unit, or the like) which measures a radio environment between radio communication apparatuses, a transmission format may be changed depending on quality. When the quality is improved, the transmission format is changed into a transmission format with a faster transmission speed. When the quality is deteriorated, the transmission format is changed into a transmission format with a lower transmission speed.

The controller 23 controls the transmitter 21 to transmit data different from the designated data and the signal C2 with a transmission region (radio resource) designated by designation information. Alternatively, the controller 23 controls the transmitter 21 to transmit data in a transmission format different from the designated transmission format with the transmission region (radio resource) designated by the designation information and controls the transmitter 21 to transmit the signal C2.

The signals C1 and C2 are desirably transmitted in a certain transmission format or conforming to the designated transmission format.

The controller 13 of the radio communication apparatus 10 controls the receiver 12 to perform a receiving process on data at a frequency and in a time period corresponding to the transmission region (radio resource) designated by the designation information, so that the controller 13 receives data transmitted conforming to the designation or data transmitted not conforming to the designation.

The controller 13 also receives the control signals (P1 and P2) transmitted from the radio communication apparatus 20. When the signal P1 is received (the signal P2 is not received), a radio communication apparatus 10 detects that a transmission region (radio resource) of further data is required to be allocated (desired to be allocated). When the signal P2 is received (the signal P1 is not received), the radio communication apparatus 10 detects that the transmission region (radio resource) of the further data is not required to be allocated (not desired to be allocated).

Therefore, the radio communication apparatus 10 can obtain desired information related to a further allocation of the transmission region (radio resource) of the further data by reception statuses of the control signals (P1 and P2). Therefore, when the radio communication apparatus 10 determines whether or not the transmission region (radio resource) for the further data is allocated in response to the reception result of the transmission data, the radio communication apparatus 10 can also use the control signal (desired by the radio communication apparatus 20).

For example, when the controller 13 detects that allocation is desired, if the controller 13 detects that reception of the transmission data cannot be correctly performed, the controller 13 generates designation information that designates a transmission region (radio resource) of re-transmission data and transmits the designation information from the transmitter 11 to make it possible to transmit the re-transmission data. On the other hand, when the controller 13 detects that allocation is not desired, if the controller 13 detects that the reception of the transmission data cannot be correctly performed, the controller 13 determines that the transmission of the re-transmission data is unnecessary and does not generate designation information which designates a transmission region (radio resource) of the re-transmission data.

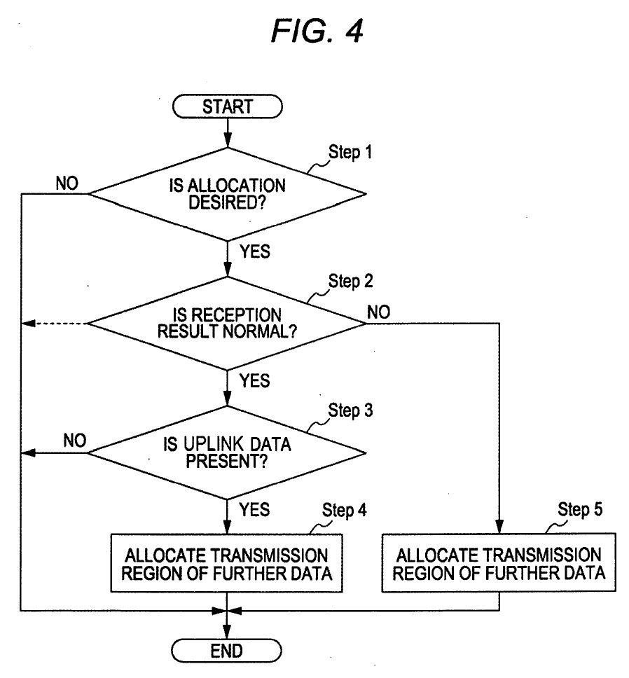

An example of a transmission region (radio resource) allocating the processing of further data to which the controller 13 conforms will be described below with reference to FIG. 4.

The controller 13 monitors the control signal P transmitted from the radio communication apparatus 20 to determine whether the transmission region (radio resource) allocation of the further data is desired or not (step 1). As a relationship between a monitor result of the control signal P and the determination, for example, the relationship described above can be used.

In this case, when the controller 13 determines that allocation is not desired, the controller 13 ends the process without allocating a further transmission region (radio resource) to the radio communication apparatus 20 to prepare for the next determination in step 1. In this manner, the controller 13 can suppress the radio communication apparatus 10 from allocating the transmission region (radio resource) even though allocation of a further transmission region (radio resource) is not desired by the radio communication apparatus 20.

When it is determined that allocation is desired in step 1, the controller 13 determines whether or not a reception result of data transmitted with the transmission region (radio resource) designated by the designation information is normal (step 2).

When it is determined that the reception result is not normal in step 2 (for example, an error is detected by CRC calculation), the controller 13 allocates a transmission region (radio resource) of further data to the radio communication apparatus 20 (step 5). More specifically, the controller 13 generates designation information that designates a transmission region (radio resource) to be used as the transmission region (radio resource) for the further data to transmit the designation information from the transmitter 11. In this case, the further data is, for example, re-transmission data of data in which an error is detected.

When it is determined that a reception result is normal in step 2 (for example, an error is not detected by the CRC calculation), the controller 13 determines whether or not there is uplink data to be transmitted by the radio communication apparatus 20 (step 3).

The determination whether there is uplink data or not can be performed such that, for example, a notification of an amount of data desired to be transmitted is received from the radio communication apparatus 20 in advance and it is determined whether or not data of the amount which reaches the desired data amount is received from the radio communication apparatus 20. More specifically, a transmission notification of data of L megabits is received from the radio communication apparatus 20. When reception of data of L/2 megabits is completed by the normal reception of the received data at this time, it can be determined that there are L/2 megabits of uplink data remaining. When all the data of the L megabits is received, it can be determined that there is no uplink data and the process can be finished. However, even though all the data of the L megabits are received in this reception, if it is determined that allocation is desired in step 1, the controller 13 may determine that there is some uplink data and can shift to the process in step 4 in another embodiment.

Even though it is determined that the reception result is normal in step 2, the controller 13 may end the process without allocating a further transmission region (radio resource) to the radio communication apparatus 20 according to a dotted arrow in FIG. 4, and can prepare for the next determination in step 1 in another embodiment. More specifically, when re-transmission is necessary, the controller 13 executes the re-transmission process by transmitting designation information which designates the transmission region (radio resource) from the transmitter to make the radio communication apparatus 20 transmit the re-transmission data. However, when the re-transmission is not necessary, the controller 13 can also receive a signal which requires a further transmission region (radio resource) from the radio communication apparatus 20 and then allocate a further transmission region (radio resource).

When it is determined that there is no uplink data in step 3, the controller 13 ends the process without allocating a further transmission region (radio resource) to the radio communication apparatus 20 to prepare for the next determination in step 1. In this manner, the controller 13 can suppress the radio communication apparatus 10 from allocating the transmission region (radio resource) even though allocation of a further transmission region (radio resource) is not desired by the radio communication apparatus 20.

When it is determined that there is uplink data in step 3, the controller 13 allocates the transmission region (radio resource) of the further data (step 4). More specifically, the controller 13 generates designation information which designates a transmission region (radio resource) to be used as the transmission region (radio resource) of the further data and transmits the designation information from the transmitter 11.

The transmission region (radio resource) designated in step 3 is the transmission region (radio resource) to transmit not retransmission data but further data (for example, new data). The designation information may include information which designates a type of data to be transmitted with the transmission region (radio resource).

The controller 13 detects that the data transmitted conforming to designation performed by the designation information is received when the controller 13 receives the signal C1 or does not receive the signal C2. The controller 13 detects that data which is not transmitted conforming to the designation performed by the designation information is received when the controller 13 receives the signal C2 or does not receive the signal C1.

As described above, even though the radio communication apparatus 10 receives the data transmitted without conforming to the designation, the radio communication apparatus 10 can detect the data. For this reason, the radio communication apparatus 20 is allowed to transmit data different from the designated data.

The radio communication apparatus 10 can also perform a different process depending on the detection.

For example, when transmission of re-transmission data is designated, if it is detected that the received data conforms to the designation, the received data is handled as the re-transmission data, and the data may be combined with the previous data of the failed reception and may be decoded to obtain a synthesized gain, so that a reception characteristic can also be improved. Furthermore, the received data is not combined with the previous data of the failed reception, the data of the failed reception is discarded, and the received data can be handled as re-transmission data not to be combined with the data of the failed reception.

On the other hand, when the received data does not conform to the designation, the received data is not re-transmission data (new data). For this reason, a process of handling the received data as data different from the previous data of the failed reception, combining the data with the previous data of the failed reception, and decoding the data can also be prohibited.

The radio communication apparatus 10 can perform a different process conforming to detection. For example, although 16 QAM is designated as the transmission format, when the signal C2 is received, the data can also be normally reproduced by trying a receiving process even in QPSK which is different from 16 QAM. When the radio communication apparatus 10 is notified of the transmission format by the signal C2, the radio communication apparatus 10 can save the trouble of trying a receiving process with respect to a finite number of all available transmission formats.

Transmission timings of the control signals (P1 and P2) may fall within the same radio frame (UL sub-frame) or may not fall within the same radio frame (UL sub-frame) as that of corresponding data. When the transmission timings fall within a radio frame prior to the data, the transmission data and the control signal P need not be transmitted around the same time. For this reason, traffic is moderated. When the transmission timings fall within the same radio frame, allocation control of a further transmission region (radio resource) depending on a reception result of data received by the control signal can be rapidly performed.

When the transmission of the control signal (P2) is performed after the radio frame in which the data is transmitted, the radio communication apparatus 10 can perform allocation control of a further transmission region (radio resource) in response to a reception result of received data and a control signal to be received later. For example, when an error correction calculating process such as turbo decoding, which requires a relatively long period of time, is performed to calculate the reception result, a long time is required to complete an error detecting process for the decoded reception signal. Therefore, even though the reception of the control signal P is delayed, allocation control of a further transmission region (radio resource) may be not disadvantageously delayed due to only the delay of reception of the control signal R The radio communication apparatus 10 differentiates the period of data transmission from the period of reception of the control signal to make it possible to distribute traffic of an uplink signal.

Transmission timings of the control signals (C1 and C2) may fall within the same radio frame (UL sub-frame) or may not fall within the same radio frame (UL sub-frame) as that of corresponding data. When the control signals are transmitted within the radio frame prior to the data, the radio communication apparatus 10 can perform preparation such as a receiving process in advance. When the timings fall within the same radio frame, a processing method for data received around the same time by the control signal can be isolated.

When the transmission of the control signal (C2) is performed after the radio frame in which data is transmitted, the radio communication apparatus 10 can also execute different receiving processes later based on the control signal received later with respect to the received data. For example, it is assumed that the reception signal is temporarily stored in a storage unit. When the signal C2 is received, a receiving process can be tried again in a reception format different from the designated reception format (QAM). Even though the reception data and re-transmission data are combined with each other, if re-transmission is designated, data of two types are stored in advance with respect to the reception data expected to be re-transmitted (temporary re-transmission data). More specifically, both temporary re-transmission data obtained before combining by a combining unit and temporary re-transmission data combined with the previously received data are stored in a storage unit, and reception of a later control signal C2 causes the temporary re-transmission data to be recognized as new data, and the data obtained before combining may be given from the storage unit to a controller 33 as new data.

The signals P1, P2, C1, and C2 are transmitted in a certain transmission format or transmitted conforming to the designated transmission format and received in a reception format corresponding to the certain transmission format or in a reception format corresponding to the designated transmission format.

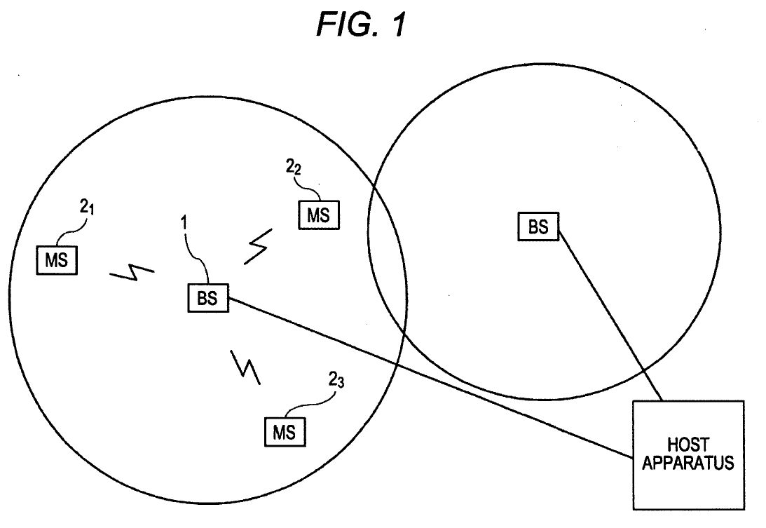

This example explains that the radio communication apparatuses 10 and 20 are set in a one-to-one status. However, as shown in FIG. 1, a plurality of radio communication apparatuses 20 may be present, the radio communication apparatus 10 may be further connected to a network-side apparatus, and the radio communication apparatus 10 may be operated as a base station which forms one cell in a cellular system. In another example, the radio communication apparatus 10 is used as a base station corresponding to IEEE802.16d/e.

An example in which an embodiment of the present invention is applied using a base station corresponding to IEEE802.16d/e as a standard will be described below. Since the MS can also be replaced with a fixed apparatus, it is assumed that the MS can be called a terminal.

As a configuration of an entire system, the configuration shown in FIG. 1 can be employed. The BS can also be connected to a terminal through a relay station (RS). However, in this case, the configuration may be understood such that the BS is replaced with the RS.

As shown in FIG. 1, the BS constitutes a cell serving as a radio area, and provides a radio service to a terminal in the cell. The BS is connected to a host apparatus to make it possible to perform communication with another BS and the network-side apparatus.

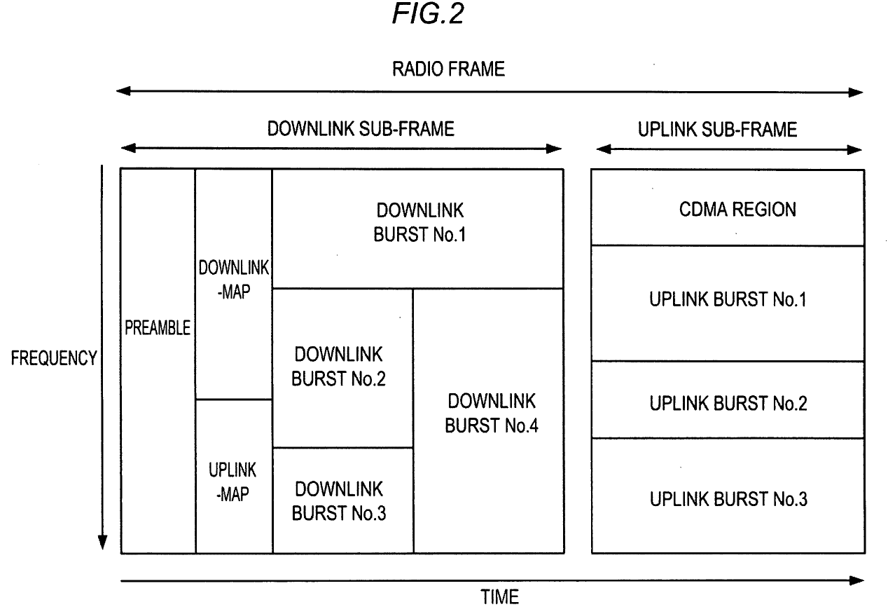

A format example of a radio frame to be used in this embodiment may be a format shown in FIG. 2. Therefore, in the embodiment, the BS performs transmission of a DL sub-frame and reception of a UL sub-frame shown in FIG. 2. Transmission region (radio resource) and transmission formats (modulation method, coding rate, number of repetitions, and the like) of a DL burst and a UL burst are defined by a DL-MAP and the UL-MAP, respectively, as described above.

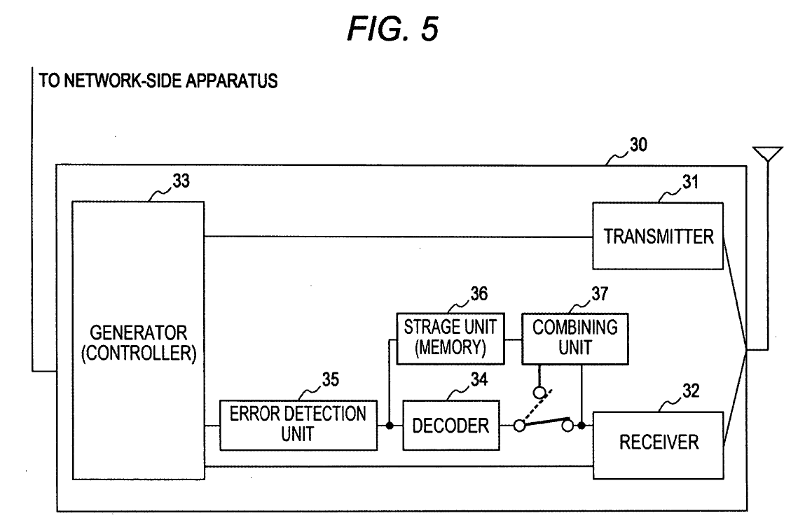

A configuration of the base station will be described below with reference to FIG. 5.

A base station 30 includes a transmitter 31, a receiver 32, a controller 33, a decoder 34, an error detection unit 35, a storage unit 36, and a combining unit 37.

The controller 33 generates a preamble, a DL-MAP, a UL-MAP, and DL bursts which form a radio frame and transmits them from the transmitter 31. The DL-MAP defines transmission region (radio resource) and transmission formats of each of the DL bursts, and the controller 33 controls the transmitter 31 to perform transmission with the transmission region (radio resource) and the transmission format defined by the DL-MAP in transmission of each of the DL bursts. The UL-MAP defines each of the UL bursts, a transmission region (radio resource) serving as a transmission region (radio resource) (CDMA Region (radio resource)) of a ranging signal, and a transmission format.

When the control signals P1, P2, C1, and C2 described above are allowed to be transmitted in a same region (radio resource) as the region (radio resource) of the data, the transmission region (radio resource) of the data and the control signal are simultaneously designated by UL-MAP information which designates a transmission region (radio resource) of uplink data.

When the control signals P1, P2, C1, and C2 described above are allowed to be transmitted in the different region (radio resource) from the region (radio resource) of the data, a transmission region (radio resource) and a transmission format of the data are designated by the UL-MAP information (UL-MAP for data) which defines the transmission region (radio resource) of the uplink data, and a transmission region (radio resource) and a transmission format of the control signal are designated by an independent piece of UL-MAP information (UL-MAP for control signal) which defines the transmission region (radio resource) of the control signal. The ranging signal is a kind of control signal, and the transmission region (radio resource) may also be classified into the control signal UL-MAP.

In any case, transmission region (radio resource) of the data and a control signal are designated by a UL-MAP.

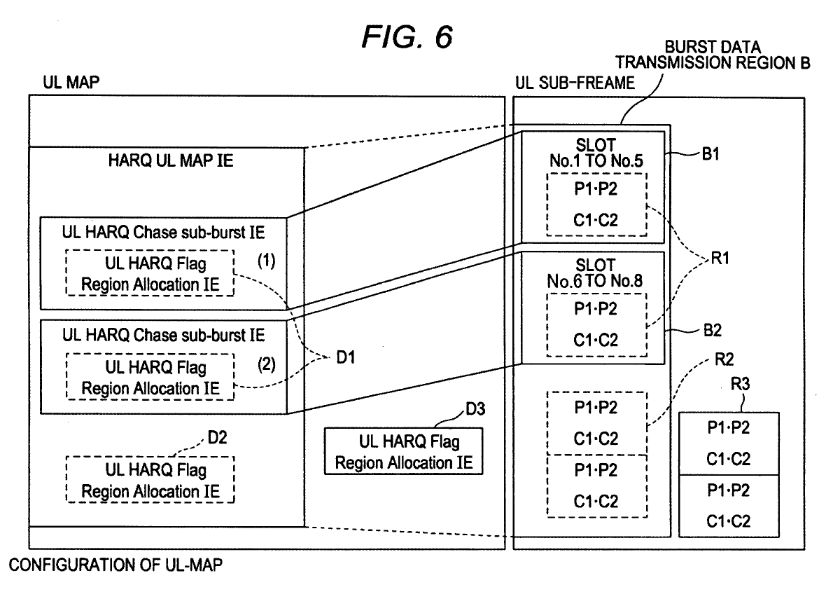

FIG. 6 illustrates a data configuration example of the UL-MAP. In this case, it is assumed that data designated by a transmission region (radio resource) is data subjected to re-transmission control.

An HARQ (Hybrid Automatic Repeat reQuest) UL MAP IE (Information Element) defines a transmission region (radio resource) (transmission block) of data subjected to re-transmission control. For example, a specific frequency and a specific time period in a UL sub-frame to which transmission of data subjected to re-transmission control is allocated are defined.

A transmission region (radio resource) allocated by the HARQ (Hybrid Automatic Repeat reQuest) UL MAP IE can be further divided by the UL HARQ Chase sub-burst IE and can also be used.

The UL HARQ Chase sub-burst IE may have, for example, a data configuration illustrated in FIG. 6.

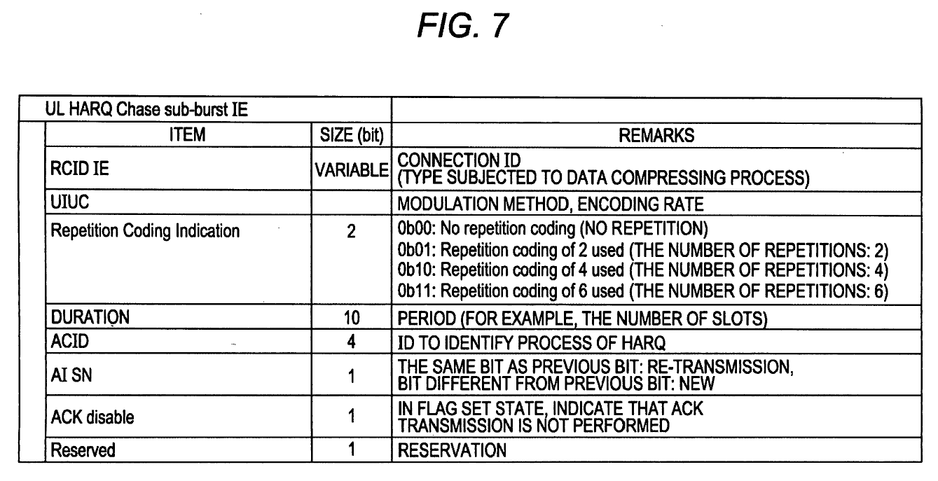

Data items may include RCID (Reduced Connection IDentifier) IE, UIUC (Uplink Interval Usage Code), Repetition Coding Identification, Duration, ACID (hARQ Channel IDentifier), AISN (hARQ Identifier Sequence Number), ACK disable, and Reserved. FIG. 7 illustrates a configuration example of the HARQ UL MAP IE when a CC (Chase Combine) method is used. However, an IR (Increment Redundancy) method, a CTC (Convolution Turbo Code) method, an IR CC (Confirmation Code) method, or the like may be employed.

The RCID IE is ID information to specify a connection between the base station 30 and a terminal 40. It is assumed that RCID to which a certain data compressing process is performed may be used here.

UIUC is information which specifies a transmission format such as a modulation method (QPSK, 16 QAM, or the like), and an coding rate (1/2, 1/3, or the like). Different numerical values are allocated to combinations between a plurality of modulation methods and a plurality of coding rates, and any one of the numerical values can also be used (transmitted) as UIUC information.

Repetition Coding Indication is information to control redundancy of transmission data stored in a UL burst. For example, repetition of the transmission data can be set to none by 0b00, the number of repetitions of the transmission data can be set to 2 (two same transmission data are stored) by 0b01, the number of repetitions of the transmission data can be set to 4 (four same transmission data are stored) by 0b10, and the number of repetitions of the transmission data can be set to 6 (six same transmission data are stored) by 0b11.

Duration indicates a period in which data is transmitted, and can indicate, for example, a period by the number of slots which allow transmission. Since the HARQ UL MAP IE can include a plurality of UL HARQ Chase sub-burst IEs, the terminal 40 specifies a transmission region (radio resource) designated by the HARQ UL MAP IE first. When the terminal 40 transmits data conforming to the second UL HARQ Chase sub-burst IE (2), shifting is performed by the number of slots (5 in this case) designated by Duration of the first UL HARQ Chase sub-burst IE (1), and data is transmitted from a sixth slot by using three slots designated by duration of the UL HARQ Chase sub-burst IE (2). More specifically, when the terminal 40 transmits data conforming to an Nth UL HARQ Chase sub-burst IE, a sum of durations of the first to (N−1)^{th} UL HARQ Chase sub-burst IEs is calculated, and data is transmitted in a (total sum +1)^{th} slot. When a UL HARQ Chase sub-burst IE includes information indicating how many slots from an Nth slot can be used for data transmission, the terminal can also specify a data transmission region (radio resource) by reception of one UL HARQ Chase sub-burst IE addressed to the terminal without receiving another UL HARQ Chase sub-burst IE.

Such designation of the data transmission region (radio resource) may be performed for each radio frame.

ACID is information representing ID to identify a process of re-transmission control (HARQ). For example, when data transmitted by the terminal 40 is transmitted in parallel to each other, different ACIDs are given to the transmission operations, respectively, to differentiate the transmission operations from each other, and re-transmission control can be executed by each of the transmission operations.

AISN can use a bit constituted by, for example, 0 and 1. When “1 (0)” is set in the previous transmission, if re-transmission is required at this time, the same “1 (0)” is set. If new transmission is required at this time, different “0 (1)” is set. Therefore, since the terminal 40 is notified of the new transmission and the re-transmission by a change of bits, the terminal 40 identifies the new transmission from the re-transmission by using both the previous bit and the bit at this time.

ACK disable is information which notifies that no HARQ ACK IE is transmitted for data sent from the terminal 40.

Reserved is a reserved free information region (radio resource).

The base station 30 also secures a transmission region (radio resource) with which the terminal 40 makes it possible to transmit the control signals P1 and P2. The base station 30 may also secure a transmission region (radio resource) with which the terminal 40 makes it possible to transmit the control signals C1 and C2.

At this time, the following region (radio resource) can be used as transmission region (radio resource) of the control signals (P1, P2, C1, and C2).

In a transmission region (radio resource) (B) of burst data designated by the HARQ UL MAP IE

When a control signal is allowed to be transmitted with a transmission region (radio resource) of each burst data

Transmission region (radio resource) of the control signals (P1, P2, C1, and C2) can also be set in a region (radio resource) indicated by R1 in FIG. 6.

In this manner, the base station 30 can efficiently receive both the data and the control signal by a receiving process for a transmission region (radio resource) of each burst data.

In FIG. 6, also by any one of D1 (in designation data which performs designation of respective burst data), D2 (in designation data which performs designation of an entire burst data transmission region (radio resource)), or D3 (out of data which designates a burst data transmission region (radio resource)), a concrete region (radio resource) R1 can be designated. The D1, D2, or D3 may be transmitted for each radio frame or may be transmitted for each plurality of radio frames.

The D1 expressly designates a transmission region (radio resource) in which a control signal should be transmitted with a transmission region (radio resource) of respective burst data. However, the base station 30 designates a transmission region (radio resource) of respective burst data, and the terminal 40 interprets the transmission region (radio resource) of the designated burst data as a transmission region (radio resource) for data and a control signal, and can transmit the data and the control signal. More specifically, in this case, although it is designated that the burst data is in the region (radio resource), a portion in which the control signal should be transmitted is not concretely designated in the burst data region (radio resource).

ii) In a transmission region (radio resource) (B) of burst data

Transmission region (radio resource) of the control signals (P1, P2, C1, and C2) can also be set in a region (radio resource) indicated by R2 in FIG. 6.

In this manner, since a transmission region (radio resource) is different from a transmission region (radio resource) of data subjected to re-transmission control, a radio environment in which data is transmitted is different from a radio environment in which a control signal is transmitted, and the base station 30 may be able to receive a control signal without being able to receive data.

In FIG. 6, a specific region (radio resource) R2 can also be designated by any one of D1 (in designation data which performs designation of respective burst data), D2 (in designation data which performs designation of an entire burst data transmission region (radio resource)), or D3 (out of data which designates a burst data transmission region (radio resource)). The D1, D2, or D3 may be transmitted for each radio frame or can be transmitted for each of a plurality of radio frames.

The D2 expressly designates a transmission region (radio resource) in which, especially, a control signal should be transmitted in a burst data transmission region (radio resource). However, the base station 30 designates a burst data transmission region (radio resource) (B), and the terminal 40 interprets a portion (remaining portion) that is not used in data transmission in the burst data transmission region (radio resource) (B) as a transmission region (radio resource) of a control signal and can also transmit the control signal.

(2) Out of the transmission region (radio resource) (B) of burst data designated by HARQ UL MAP IE

Transmission region (radio resource) of control signals (P1, P2, C1, and C2) can also be set in the region (radio resource) indicated by R3 in FIG. 6.

In this manner, since a transmission region (radio resource) is different from that of data subjected to re-transmission control, a radio environment in which data is transmitted may be different from a radio environment in which a control signal is transmitted, and the base station 30 may be able to receive a control signal without being able to receive data. Since a region (radio resource) further separated from the data transmission region (radio resource) is used as the transmission region (radio resource) of the control signal, a different radio environment can be more easily obtained.

In FIG. 6, a region (radio resource) R3 can be designated also by any one of D1 (in designation data which performs designation of respective burst data), D2 (in designation data which performs designation of an entire burst data transmission region (radio resource)), or D3 (out of data which designates a burst data transmission region (radio resource)). The D1, D2, or D3 may be transmitted for each radio frame or can be transmitted for each of a plurality of radio frames.

The transmission region (radio resource) of the signals P1, P2, C1, and C2 can be distributed to any one of the region (radio resource) R1 to R3 without being set in one region (radio resource).

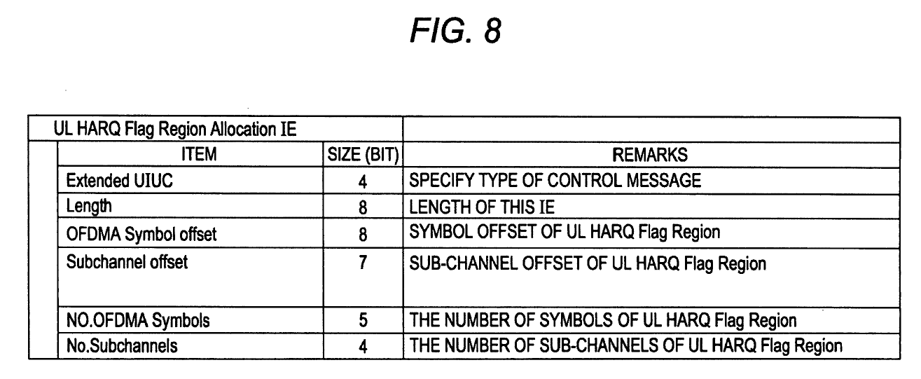

FIG. 8 illustrates an example of designation information obtained when transmission region (radio resource) of control signals are designated by D1, D2, or D3. In this case, it is assumed that designation information which designates a transmission region (radio resource) or the like of the control signal is called a UL HARQ flag Region (radio resource) Allocation IE.

The UL HARQ flag Region (radio resource) Allocation IE includes Extended UNIUC, Length, OFDMA Symbol offset, Subchannel offset, No. OFDMA Symbols, and No. Subchannels.

“Extended UIUC” is information indicating a type of a message and means a message which defines a transmission region (radio resource) of a control signal.

“Length” indicates a length of the message.

“OFDMA Symbol offset” “Subchannel offset” “No. OFDMA Symbols” and “No. Subchannels” are pieces of information that define a transmission region (radio resource) in which a control signal should be transmitted. “OFDMA Symbol offset” indicates the number of symbols by which a timing (start timing) where a transmission region (radio resource) of a control signal is started is delayed from a reference timing (for example, a head of a preamble, a head of UL subframe, or a head of DL burst) in a radio frame. “Subchannel offset” indicates the number of sub-channels by which a sub-channel (start sub-channel) where the transmission region (radio resource) of the control signal is started is separated from one end of a sub-channel to be used. “No. OFDMA Symbols” indicates the number of symbols through which the transmission region (radio resource) of the control signal continues from the start timing. “No. Subchannels” indicates the number of sub-channels through which the transmission region (radio resource) of the control signal continues from the start sub-channel.

The designation of the transmission region (radio resource) is not limited to the designations described above.

The receiver 32 of the base station 30 receives data (for example, data and control signals (P1, P2, C1, and C2) transmitted in the UL burst region (radio resource)) received from the terminal 40. The receiver 32 receives a signal transmitted from each of the terminals 40 with a transmission region (radio resource) designated by the HARQ UL MAP IE (transmitted by a UL sub-frame in a radio frame which transmits a UL-MAP or transmitted after a certain number of frames [for example, a UL sub-frame of the next radio frame] from the UL sub-frame in the radio frame which transmitted the UL-MAP) in a reception format corresponding to a transmission format designated by each UL HARQ Chase sub-burst IE.

When new transmission is set by AISN, the receiver 32 gives transmission data from the terminal 40 to the decoder (for example, an error decoder such as a turbo decoder) 34, causes the storage unit 36 to store a decoding result, and causes the error detection unit (CRC check unit or the like) 35 to execute error detection.

When the error detection unit 35 does not detect an error, the error detection unit 35 discards data stored in the storage unit 36 (makes it overwritable) and gives the reception data to the controller 33. At this time, the error correction unit 35 also preferably gives an identification bit indicating that reception is successful to the controller 33.

When the controller 33 detects that reception is successful, the controller 33 gathers received data of the same connections on the basis of RCID and couples the data if necessary. The coupled data is transferred to a host apparatus on a network side and is transferred to a certain destination, so that communication may be executed between the terminal 40 and the destination apparatus.

Since the controller 33 can determine that re-transmission is unnecessary due to successful reception, a bit changing process is performed for AISN selected from RCID, ACID, and AISN to change the meaning to a new transmission, a UL HARQ Chase sub-burst IE is generated and transmitted by the next radio frame. For this reason, as a similar process, the terminal 40 may be urged to transmit the next data. A transmission region (radio resource) or the like may be reset by the HARQ UL MAP IE. A transmission region (radio resource) of UL burst data obtained by HARQ UL MAP IE is variable.

When the error detection unit 35 detects an error, the error detection unit 35 causes the storage unit 36 to store erroneous data in association with RCID and ACID. Since the error detection unit 35 notifies the controller 33 of the error together with RCID and ACID, the controller 33 performs a bit changing process to AISN selected from RCID, ACID, and AISN to change the meaning to re-transmission. The controller 33 generates a UL HARQ Chase sub-burst IE and transmits the UL HARQ Chase sub-burst IE by the next radio frame. In this manner, the terminal 40 can be urged to re-transmit data as the same process. A transmission region (radio resource) or the like may be reset by the HARQ UL MAP IE.

When the data is re-transmitted, the receiver 32 receives the data and gives the received data to the combining unit 37. Since the combining unit 37 is notified of RCID and ACID of the received data by the controller 33, the combining unit 37 reads corresponding data from the storage unit 36, combines the data with the re-transmitted received data, and gives a combining result to the decoder 34. Combining (for example, maximum ratio combining) at a signal level is performed by a process such as a process of averaging likelihoods of signals.

The decoder 34 performs decoding on the basis of the combined data and gives a decoding result to the error detection unit 35 and the storage unit 36 to prepare for further re-transmission.

Subsequent operations or the like of the error detection unit 35 are the same as those described above.

As described above, the base station 30 combines data of the failed reception with re-transmission data to obtain a combining gain, so that the number of times of re-transmission can be reduced. The controller 33 can also decode re-transmitted data again without being combined. If the decoded data has no error, the base station 30 can cause the terminal 40 to transmit new data. If the decoded data has an error, the base station 30 can also cause the terminal 40 to transmit further re-transmission data.

The receiver 32 of the base station 30 receives not only data but also the control signals (P1, P2, C1, and C2) from the terminal 40 and gives a reception result to the controller 33.

When the controller 33 detects that further allocation of a transmission region (radio resource) of further data (P1 is received or P2 is unreceived) is desired, depending on a reception result of the data, the controller 33 performs allocation control of the data transmission region (radio resource) to the terminal 40. As a concrete process, a process related to FIG. 4 described above may be performed.

When the controller 33 detects that allocation of the transmission region (radio resource) of the further data is not desired (P2 is received or P1 is unreceived), depending on a reception result of the data, the controller 33 does not allocate the transmission region (radio resource) of the data to the terminal 40. As a concrete process, a process related to FIG. 4 described above can be performed.

As described above, the base station 30 can use the control signals (P1 and P2) to determine whether further allocation of a transmission region (radio resource) of further data is performed in the terminal 40 or not. For example, even though the base station 30 could not correctly receive transmission data, when the base station 30 receives the control signal P2, the base station 30 considers the allocation of the transmission region (radio resource) for re-transmission data as an unnecessary operation. For this reason, allocation of the transmission region (radio resource) may be avoided. A transmission region (radio resource) can also be allocated to transmit other new data.

When the controller 33 receives a control signal (C1) indicating that the data is data corresponding to the data designated by designation information (or does not receive the signal C2), the controller 33 performs a process scheduled by designation.

For example, when transmission of re-transmission data is designated by the designation information as expected, a reception signal with respect to re-transmitted data is given to the combining unit 37 and combined with a signal stored in the storage unit 36 to perform decoding again.

When the controller 33 receives a control signal (C2) indicating that data is not data corresponding to the data designated by the designation information (does not receive the signal C1), the controller 33 performs a process different from the process scheduled by the designation.

For example, when transmission of re-transmission data designated by the designation information is different than expected, the re-transmission data is given to the decoder 34 without performing a combining process of a reception signal with respect to transmission data (for example, new data) different from designated re-transmission data. The decoder 34 gives a decoding result to the controller 33 through the error detection unit 35.

In this manner, by using the control signals C1 and C2, even though data different from designated data is transmitted, the base station 30 can be properly operated.

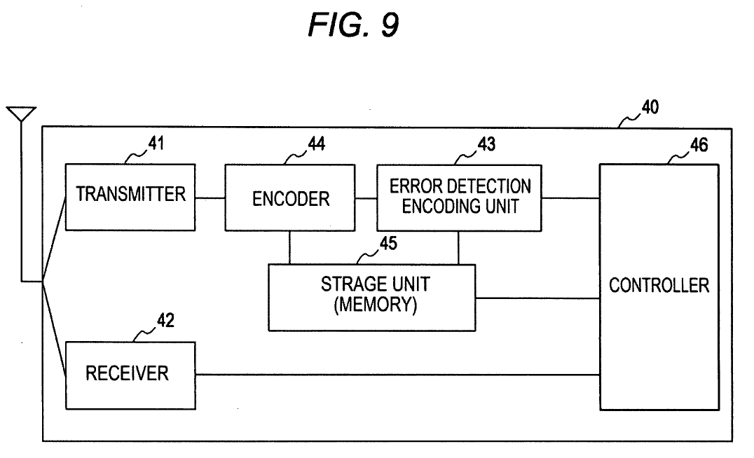

FIG. 9 illustrates a configuration example of a terminal as an example of a radio communication apparatus.

In FIG. 9, reference numeral 40 denotes a terminal; 41 denotes a transmitter; 42 denotes a receiver; 43 denotes an error detection encoding unit; 44 denotes an encoder; and 45 denotes a storage unit.

The receiver 42 synchronizes with a radio frame timing by using a preamble transmitted from the base station 30 to receive UL-MAP and DL-MAR

When the controller 46 of the terminal 40 receives a transmission region (radio resource) and transmission format information of a DL burst corresponding to CID to be received by the controller 46 in DL-MAP, the controller 46 controls the receiver 42 to receive information transmitted from the base station 30 with the transmission region (radio resource) and the transmission format. The data received by the receiver 42 is given to the controller 46 and subjected to a desired process. The reception data (for example, audio and image information) subjected to the desired process is output to a display, an audio output unit, or the like (not shown).

The receiver 42 receives the HARQ UL MAP IE (especially, MAP information addressed to the receiver 42) when transmission data subjected to re-transmission control are present and transmission region (radio resource) of a ranging signal defined in UL-MAP.

A ranging region (radio resource) is a region (radio resource) used for transmitting ranging signals when mobile stations enter a network, and ranging signals are used to control transmission frequencies and transmission timing of radio signals transmitted by mobile stations. Since the ranging region (radio resource) is shared by another terminal, when the same timing as that of another terminal is selected, collision of signals may occur. However, when a code selected from a plurality of CDMA codes is used, the code may be isolated to some extent. For this reason, when codes are different, simultaneous transmission may also be allowed.

Reception data of the HARQ UL MAP IE is analyzed by the controller 46 and is used to specify a burst data transmission region (radio resource) and a transmission region (radio resource) in which data should be transmitted in the burst data transmission region (radio resource).

More specifically, when the RCID corresponding to the controller 46 is stored in the UL HARQ Chase sub-burst IE (2) included in an HARQ UL MAP IE, the controller 46 of the terminal 40 specifies slots No. 6 to No. 8 in the burst transmission region (radio resource) as a transmission region (radio resource) of data and transmits data from the transmitter 41 in the region (radio resource) by the method described above. Any transmission data obtained before error detection encoding, after error detection encoding, and/or after encoding (after error correction encoding such as turbo encoding) is stored in the storage unit 45 to prepare for re-transmission. The transmission data is stored in association with ACID. In re-transmission, a stored signal is read from the storage unit 45 and given to a corresponding unit to execute the remaining processes to be performed.

When RCID corresponding to the controller 46 is stored in the UL HARQ Chase sub-burst IE (2) included in the HARQ UL MAP IE, and when AISN is not different from the AISN received in advance, the controller 46 detects that re-transmission is necessary. The controller 46 similarly reads data corresponding to ACID included in the UL HARQ Chase sub-burst IE and causes the transmitter 41 to perform transmission in a designated transmission region (radio resource) and a designated transmission format.

When RCID corresponding to the controller 46 is stored in the UL HARQ Chase sub-burst IE (2) included in the HARQ UL MAP IE, and when AISN is different from the AISN received in advance, the controller 46 detects that a new transmission is designated and causes the transmitter 41 to transmit new data. At this time, the transmission is still performed with the designated transmission region (radio resource) and the designated transmission format.

When the terminal 40 desires to allocate a transmission region (radio resource) for further data to the base station 30, the terminal 40 transmits the signal P1 with a transmission region (radio resource) of the designated control signal (does not transmit the signal P2). When the terminal 40 does not desire to allocate the transmission region (radio resource) of the further data, the terminal 40 transmits the signal P2 with a transmission region (radio resource) of a designated control signal (does not transmit the signal P1).

Various statuses in which the terminal 40 (the controller 46) determines that further allocation of the transmission of the further data is not desired are possible.

For example, when the terminal 40 transmits Voice over IP (VoIP) data or application data such as data of video telephone having high real-time properties, if the transmission is performed over an allowable delay time, the data may not be worth transmitting from the terminal 40.

For example, although the VoIP data may reach the base station 30 within a time limit to which the data should be transmitted, when the base station 30 fails in reception of this VoIP data, the transmission region (radio resource) of re-transmission data set depending on the failure in reception may exceed the time limit to which the data should be transmitted.

Even though the VoIP data includes time limit information, when the reception fails, the base station 30 cannot confirm the information and requests re-transmission. On the other hand, even though the terminal 40 tries to perform re-transmission in response to a requested re-transmission, data which is not required to be transmitted now is transmitted. For this reason, useless data is transmitted. The terminal 40 may have discarded the data already as unnecessary data.

Therefore, even though a transmission region (radio resource) of re-transmission data is allocated by the base station 30 due to the failure in reception of the transmission data, when the controller 46 of the terminal 40 detects that transmission of the transmission data will be performed over the time limit, the controller 46 transmits the signal P2 or does not transmit the signal P1 to make it possible to cause the base station 30 to uselessly allocate the transmission region (radio resource) of the re-transmission data.

When the terminal 40 transmits data corresponding to data designated by the base station 30, the terminal 40 transmits the signal C1 with a transmission region (radio resource) of a designated control signal (does not transmit the signal C2). When the terminal 40 transmits data which does not correspond to the designated data to the base station 30, the terminal 40 transmits the signal C2 with the transmission region (radio resource) of the designated control signal (does not transmit the signal C1).

Various situations in which designated data is not transmitted to the base station 30 are possible.

For example, when the terminal 40 transmits Voice over IP (VoIP) data or application data such as data of video telephone having high real-time properties, if the transmission is performed over an allowable delay time, the data may not be worth transmitting from the terminal 40.

For example, although the VoIP data transmission exceeds a time limit to which the data should be transmitted, normal transmission may not be completed due to failure in reception at the base station 30.

Even though the data includes time limit information, the base station 30 cannot confirm the information when the reception fails and the base station 30 requests re-transmission. On the other hand, even though the terminal 40 tries to perform re-transmission in response to the requested re-transmission, data which is not required to be transmitted now is transmitted. For this reason, the data is uselessly transmitted. However, when the terminal 40 does not transmit any data, a transmission region (radio resource) designated for re-transmission is wasted.

Therefore, the terminal 40 desirably transmits data different from the designated re-transmission data. This is because the priority of the low-value re-transmission data is higher than the priority of different data.

Not only in re-transmission control but also in transmission of data different from designated data, the terminal 40 transmits information indicating that the data is different or information representing a type of the different data with a transmission region (radio resource) of a control signal designated as the control signal (C2), so that the base station 30 can avoid trouble caused by reception of unexpected data.

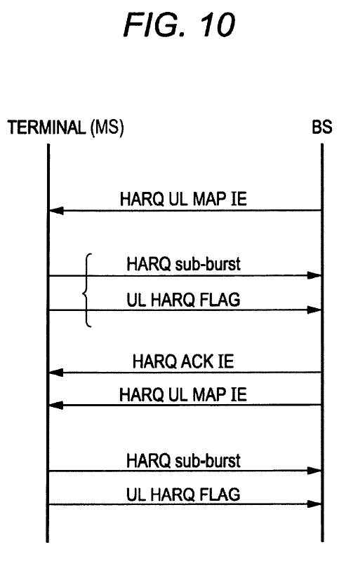

FIG. 10 illustrates a procedure used when re-transmission control is performed.

The base station 30 designates a data transmission region (radio resource) and a control signal and data (new data and re-transmission data) to be transmitted with the transmission region (radio resource) by an HARQ UL MAP IE (UL HARQ Chase Sub-Burst IE).

The terminal 40 transmits the data designated by an HARQ sub-burst or the data different from the designated data with the designated transmission region (radio resource) and transmits the corresponding control signals (C1 and C2) as a UL HARQ Flag with the transmission region (radio resource) of the control signal. The data and the control signals are preferably transmitted in the same UL sub-frame to reduce process delay.

The base station 30 notifies the terminal that reception is possible or not by the HARQ ACK IE as needed. This notification may not be necessarily performed.

The HARQ UL MAP IE (UL HARQ Chase Sub-Burst IE) requests the terminal to transmit new data or re-transmission data.

The terminal 40 transmits the data designated by an HARQ sub-burst or the data different from the designated data with the designated transmission region (radio resource) and transmits the corresponding control signals (C1 and C2) as a UL HARQ Flag with the transmission region (radio resource) of the control signal.

The terminal 40 transmits the control signals (P1 and P2) indicating that re-transmission of data to be transmitted is desired or not as a UL HARQ Flag with a transmission region (radio resource) of the control signal.

When the data to be transmitted is correctly received by the base station 30, the terminal 40 can also transmit the control signals (P1 and P2) indicating that transmission (region (radio resource)) of further data is desired or not as a UL HARQ Flag with the transmission region (radio resource) of the control signal. More specifically, even though the terminal 40 performs this transmission, the terminal 40 transmits the signal P1 (does not transmit the signal P2) when the terminal 40 detects that data to be transmitted still remains.

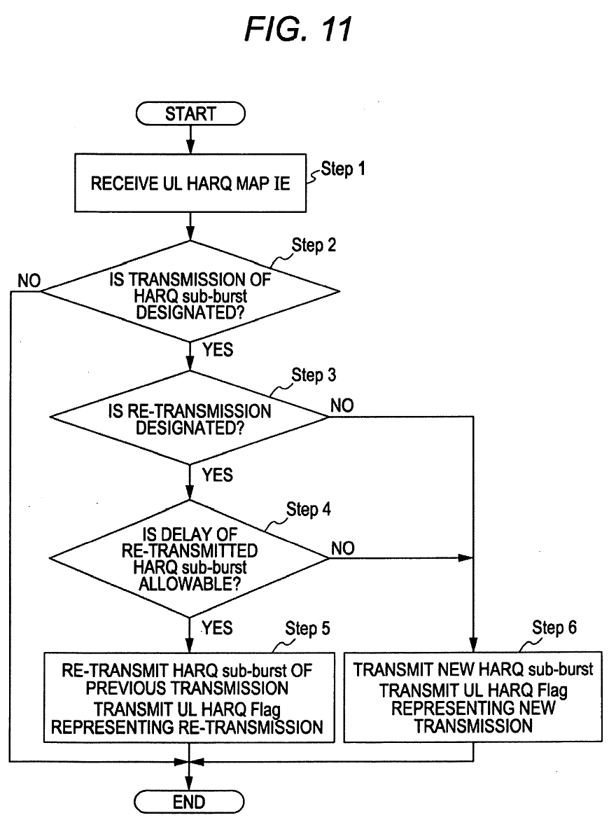

FIG. 11 illustrates an example of an operation flow of the terminal.

The terminal 40 receives a UL HARQ MAP IE (step 1).

The terminal 40 determines whether or not transmission of the HARQ sub-burst to the terminal 40 is designated (step 2). If No in step 2, the terminal 40 ends the process to return to step 1.

If Yes in step 2, the terminal 40 determines whether or not re-transmission is designated (step 3).

When re-transmission is designated, the terminal 40 determines whether or not the re-transmitted HARQ sub-burst is transmitted within an allowable delay time (whether or not data is transmitted by designation) (step 4).

In this case, when the re-transmitted HARQ sub-burst falls within the allowable delay time, the terminal 40 re-transmits the previously transmitted HARQ sub-burst and transmits the signal C1 as a UL HARQ Flag (does not transmit the signal C2) (step 5). When the base station 30 fails to receive the data re-transmitted at this time, if it is determined that a transmission region (radio resource) (for example, the next radio frame of this radio frame and a radio frame after the next radio frame) predicted to be allocated for further re-transmission falls within an allowable delay time (T), the terminal 40 transmits the signal P1 included in the UL HARQ Flag. If it is determined that the transmission region (radio resource) (for example, the next radio frame of this radio frame and a radio frame after the next radio frame) predicted to be allocated for further re-transmission falls outside the allowable delay time (T), the terminal 40 transmits the signal P2 included in the UL HARQ Flag.

In this case, when the HARQ sub-burst falls outside the allowable delay time, the terminal 40 transmits a new HARQ sub-burst and transmits the signal C2 as a UL HARQ Flag (does not transmit the signal C1) (step 6).

When the base station 30 fails to receive this transmission, if it is determined that a transmission region (radio resource) (for example, the next radio frame of this radio frame and a radio frame after the next radio frame) predicted to be allocated for re-transmission falls within the allowable delay time (T), the terminal 40 transmits the signal P1 included in the UL HARQ Flag. If it is determined that the transmission region (radio resource) (for example, the next radio frame of this radio frame and a radio frame after the next radio frame) predicted to be allocated for re-transmission falls outside the allowable delay time (T), the terminal 40 transmits the signal P2 included in the UL HARQ Flag.

When the terminal 40 does not desire re-transmission regardless of a reception result (when transmission data does not need to be re-transmitted), the terminal 40 may transmit the signal P2 regardless of the allowable delay time.

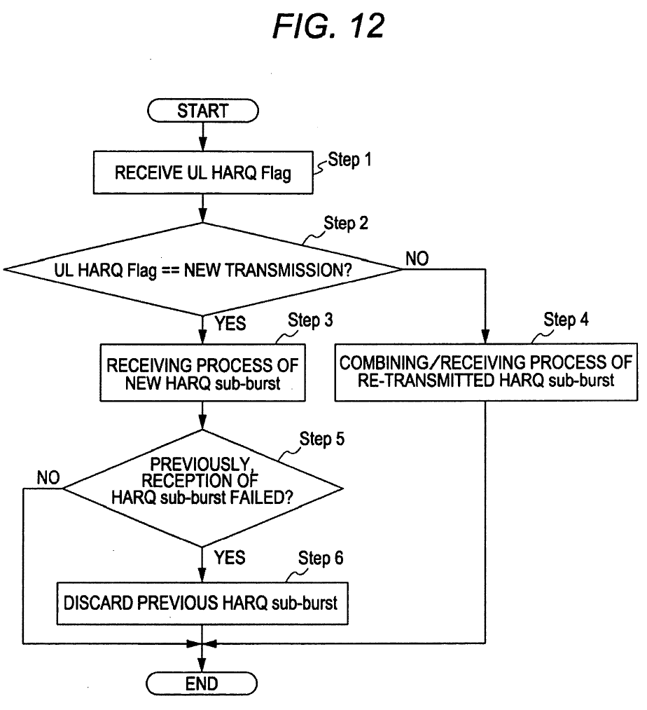

FIG. 12 illustrates an example of an operation flow of the base station.

The base station 30 receives the UL HARQ Flag (step 1).

The base station 30 determines whether or not the designated data is transmitted (step 2) by the UL HARQ Flag. When a new transmission is designated, the base station 30 determines “Yes” when the base station 30 receives the control signal C1 (does not receive the signal C2). When re-transmission is designated, the base station 30 determines “Yes” when the base station 30 receives the control signal C2 (does not receive the signal C1). In other cases, the base station 30 can determine “No”.

When “No” is determined in step 2, the base station 30 executes a combining/receiving process of the re-transmitted HARQ sub-burst (step 4), ends the process, and returns to step 1.

When “Yes” is determined in step 2, the base station 30 performs a receiving process of a new HARQ sub-burst (step 3) and determines whether or not the previous HARQ sub-burst reception failed (step 5).

When “No” in step 5, the base station 30 ends the process to return to step 1.

When “Yes” in step 5, the base station 30 discards the previously received HARQ sub-burst (makes it possible to delete or overwrite data stored in the storage unit) and returns to step 1.

In step 1, the base station 30 monitors a reception status of the control signal P (P1 or P2) in the UL HARQ Flag and performs the processes shown in FIG. 4 and described in the explanation corresponding to FIG. 4.

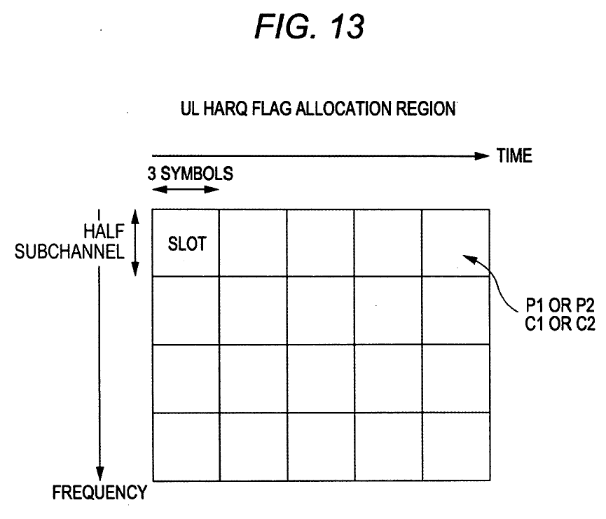

FIG. 13 illustrates an example of an allocation region (radio resource) in which the UL HARQ Flag is transmitted.

In this example, it is assumed that one region (radio resource) in which a control signal is transmitted includes a slot and a portion shown in FIG. 13. For example, it is assumed that one slot has time corresponding to a sub-carrier corresponding to a half of a sub-channel and three symbols. In this slot, the control signal P1 or P2 and the control signal C1 or C2 are transmitted.

In the explanation described above, the signal C1 is transmitted conforming to designation, and the signal C2 is transmitted not conforming to designation. However, even though the signal C1 is newly transmitted, and even though the signal C2 is re-transmitted, the base station 30 can detect that data is different from the data obtained by the previous designation by comparing the signals C1 and C2 with the signals obtained by the previous designation performed by the base station 30.

When the slot can store the plurality of signals P1, P2, C1, and C2 with redundancy, the plurality of signals P1, P2, C1, and C2 may be allowed to be stored in the slot.

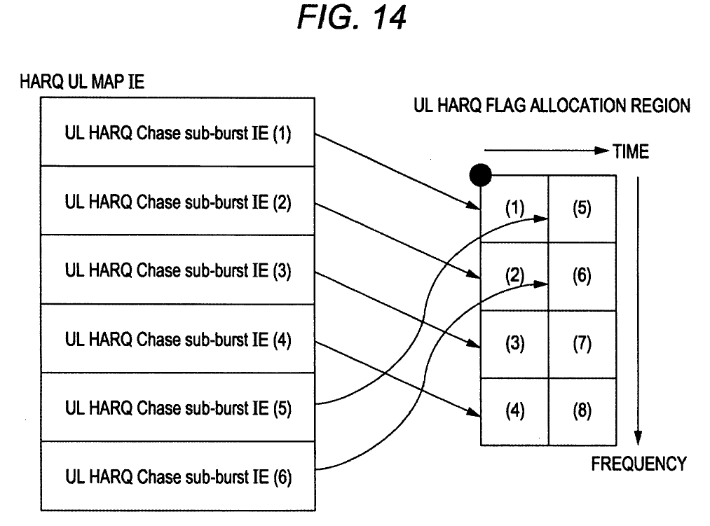

FIG. 14 illustrates an example in which it is not expressly designated (calculation is necessary) that a specific portion (slot) of the transmission region (radio resource) of the control signal should be used in transmission of the signals P1, P2, C1, and C2 to each terminal.

When the terminal 40 determines that, for example, the fifth UL HARQ Chase sub-burst is addressed to the terminal 40 and is transmitted, the terminal 40 transmits a control signal by a fifth slot in the region (radio resource) of the control signal by using the fact that the UL HARQ Chase sub-burst IE is the fifth UL HARQ Chase sub-burst IE.

More specifically, the terminal 40 counts five slots in a direction in which a frequency increases from a start point (see black circle in FIG. 14) of the transmission region (radio resource) of the designated control signal.

In this example, since the transmission region (radio resource) of the control signal corresponding to only four slots is allocated in the frequency direction, the time is increased by one slot, a transmission region (radio resource) of a slot indicated by (5) is specified, and the terminal 40 transmits the control signal in the specific slot (5).

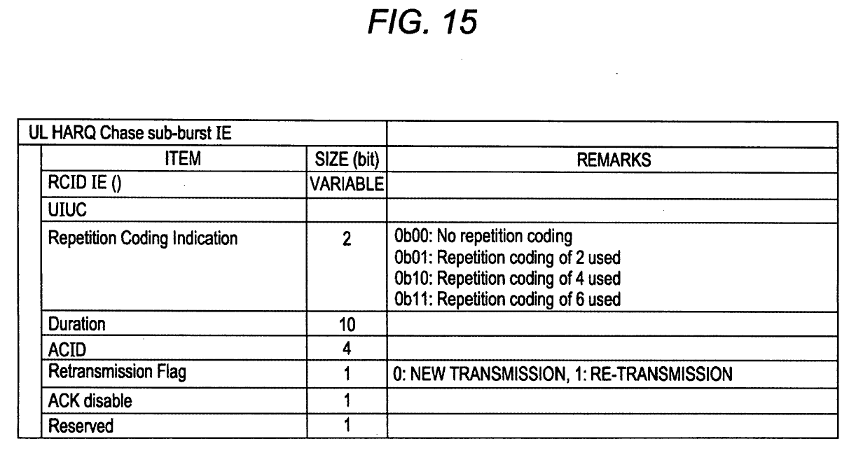

In FIG. 15, the UL HARQ chase Sub-burst IE includes a flag (Retransmission Flag) indicating that a new transmission or re-transmission is required. AISN is to notify that the new transmission or the re-transmission is required depending on a change of bits. However, the Retransmission Flag can be determined such that the new transmission is required when the Retransmission Flag is 0 and the re-transmission is required when the Retransmission Flag is 1.

Therefore, the terminal 40 can also recognize that slots, in which the Retransmission Flags are 1, to transmit control signals are used.

More specifically, each terminal transmits a control signal when the Retransmission Flag is 1.

When the terminal 40 detects that the third UL HARQ Chase Sub-burst IE is addressed to the terminal 40, the terminal 40 counts the number beforehand of the UL HARQ Chase Sub-burst IEs in which the Retransmission Flags are 1. Since the number is 1, the terminal 40 recognizes the second slot as a slot to be used and transmits a control signal in the slot indicated by (3). Accordingly, a transmission region (radio resource) of an uplink signal consumed for a control signal is reduced.

Although the control signals P and C are used in the above example, only the control signal P of the control signals P and C can be used.

According to the above embodiment, a radio communication apparatus to which a transmission region (radio resource) is designated can give a chance to be concerned about a further allocation determination of a further transmission region (radio resource) in a radio communication apparatus which designates a transmission region (radio resource).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A communication method for a radio communication system in which a second radio communication apparatus transmits a radio signal with a transmission radio resource designated by a first radio communication apparatus, the communication method comprising:
designating, by the first radio communication apparatus, a transmission radio resource for data and a control signal to the second radio communication apparatus;
transmitting, by the second communication apparatus, transmission data and a control signal with the designated transmission radio resource; and
determining, by the first radio communication apparatus, whether a further allocation of a transmission radio resource for data to the second radio communication apparatus in response to a reception result of the transmission data is performed or not based on the control signal.

2. The communication method according to claim 1, wherein the further allocation of the transmission radio resource for the data corresponds to an allocation of a transmission radio resource for retransmission data of the transmission data or a transmission radio resource for another transmission data different from the transmission data.

3. The communication method according to claim 1, wherein the control signal, when the reception result indicates that reception of the transmission data is not normally performed, indicates that allocation of a transmission radio resource for re-transmission data to the second radio communication apparatus is unnecessary or that allocation of a transmission radio resource of re-transmission data to the second radio communication apparatus is necessary.

4. The communication method according to claim 1, wherein the transmission data and the control data are transmitted in a same radio frame.

5. The communication method according to claim 1, wherein the designating of the transmission radio resource for the data or the control signal by the first radio communication apparatus is performed frame by frame.

6. The communication method according to claim 1, wherein the designating of the transmission radio resource by the first radio communication apparatus is performed by separately designating the transmission radio resource for the data and the transmission radio resource for the control signal.

7. A radio communication apparatus corresponding to a first radio communication apparatus in a radio communication system in which a second radio communication apparatus transmits a radio signal with a transmission radio resource designated by the first radio communication apparatus, the radio communication apparatus comprising:
a controller configured to generate designation information including designation of a transmission radio resource for data and a control signal to the second radio communication apparatus;
a transmitter configured to transmit the designation information generated by the controller; and
a receiver configured to receive a transmission data and a control signal from the second radio communication apparatus with the designated transmission radio resource, wherein the controller determines whether a further allocation of transmission radio resource for data to the second radio communication apparatus in response to a reception result of the transmission data received is performed or not based on the control signal received.

8. A radio communication apparatus corresponding to a second radio communication apparatus in a radio communication system in which the second radio communication apparatus transmits a radio signal with a transmission radio resource designated by a first radio communication apparatus, the radio communication apparatus comprising:
a receiver configured to receive designation information including designation of a transmission radio resource for data and a control signal from the first radio communication apparatus;
a transmitter configured to transmit a radio signal to the first radio communication apparatus; and
a controller configured to control the transmitter to transmit a transmission data and a control signal with the transmission radio resource designated by the designation information, wherein the control signal is used, by the first radio communication apparatus, to determine whether or not a further allocation of a transmission radio resource of data in response to a reception result of the transmission data is performed.
